(19) United States
(12) Patent Application Publication
(10) Pub. No.: US 2008/0164085 A1
(43) Pub. Date: Jul. 10, 2008

(54) System To Build A Steerable And Inclinable Vehicle With 3, Or 4 Wheels

(76) Inventor: Gianfranco Cecinini, Roma (IT)

Correspondence Address: YOUNG & THOMPSON, 209 Madison Street, Suite 500, ALEXANDRIA, VA, 22314, US

(21) Appl. No.: 11/794,757

(22) PCT Filed: Jan. 4, 2006
(86) PCT No.: PCT/IT2006/000001

§ 371 Date: Jul. 5, 2007

(30) Foreign Application Priority Data
Jan. 5, 2005 (IT) RM 2005 A000004

(51) Int. Cl. B62D 61/06; B62K 5/00

(52) U.S. Cl. 180/210; 280/267

(57) ABSTRACT

The necessity to get higher degrees of safety through better stabilities of the “Scooter-Cyclemotor-Bicycle-Motorcycle” has made these 2 kinds of assemblies (front and rear). The Front assembly always has forwarding the “2 steering, inclining, shock-absorbing, braking, parallel front wheels” and with the already existent 1 rear-wheel in the rear side, or with the Rear-assembly, that has the “2 inclining, shock-absorbing, braking, parallel rear-wheels” (Page: 1,2,3,4,5,6,7./7). Those 2 kind of assemblies are singularly, or both, suitable to build a vehicle with ‘3, or 4 wheels ’ (with 2 rear-wheels), always determining 3 or 4 points of contact on the ground (not only 2). The vehicle with ‘3, or 4 wheels’ is safer, it's more vertical steady and answers the highest degrees safeties either, with a second passenger on board, or with major loads upon (like heavier accumulators use for electric or hybrid power and/or if it uses major load-structures like new body carriage). The vehicle is always safe especially when adverse metheo-conditions happen (stormy weather, snowing, hailing etc.), or in specific unbalanced conditions (like in up or down dangerous pending roads “in uphill or downhill”). Then the Front-assembly with, or w/o the Rear-assembly offers the following advantages in: .A) STAND UP STABILITY in ‘parking mode’.B)STAND UP STABILITY in ‘marching and in turning mode’ (without or with braking) .C) AGILITY inside SECURITY either in the urban traffic or in highways. .D) GOOD ROADABILITY.

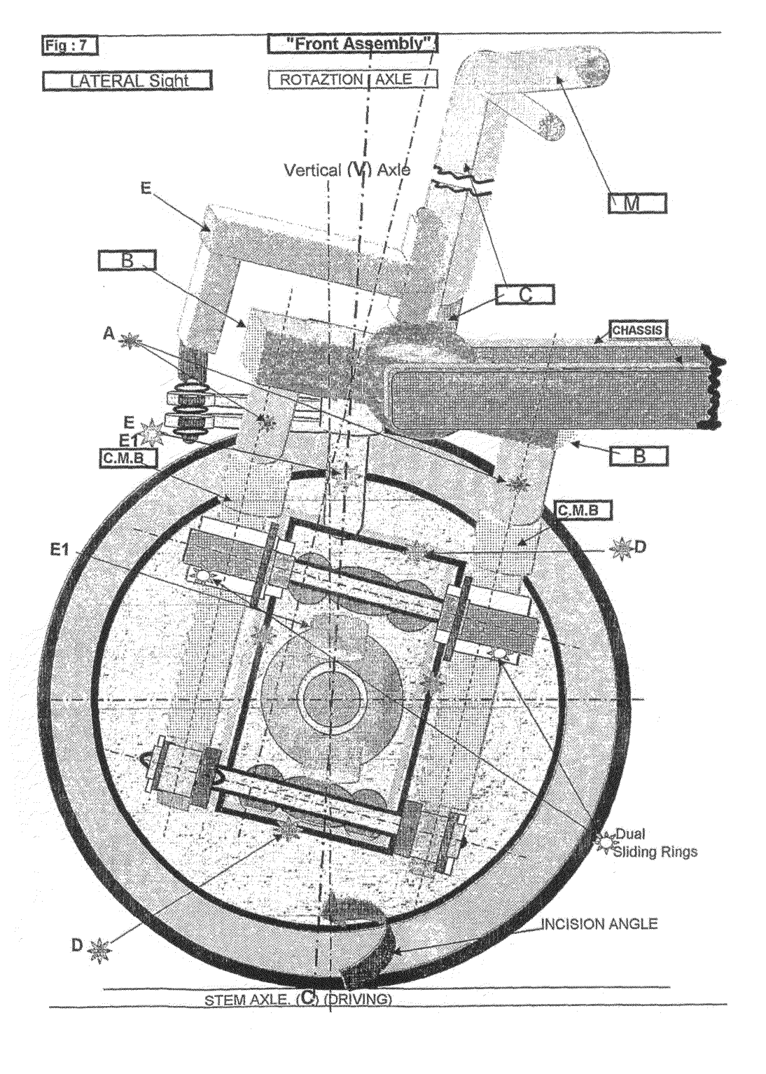

System to build a steerable and inclinable vehicle with 3, or 4 wheels and/or to transform “Scooter-Cyclemotor-Bicycle-Motorcycle” into a steerable and inclinable vehicle with 3, or 4 wheels. The System (Page1/7=FIGS.: 1,2,3,4) includes:
The “Front Assembly”, that has the “2 steering, inclining, shock-absorbing, braking, parallel rear wheels”.
The “Rear assembly” that has the “2 inclining, shock-absorbing, braking, parallel rear wheels”.
   NOTES: The “Front Assembly”, is suitable to build a 3 wheels vehicle (with only 1 rear wheel). The “Front assembly” with the “Rear Assembly” are suitable to build a 4 wheels vehicle. These 2 Assemblies are singularly, or both, suitable to build a vehicle with 3, or 4 wheels (2 rear). The “Front Assembly”, always has “2 steering, inclining, shock-absorbing, braking parallel front wheel either in singular application to build a vehicle with 3 wheels, or in the other application with 4 wheels
The “Front assembly”(forwarding)(Page 2/7=FIG. 5) consists of a fork with 2 parallel telescopic shock-absorbers(A) with mobile lower bodies (C.M.B.)(lieing low into the central vertical moving plane, namely rotating of 90° to the other actual shock-absorbers(A)). Internally, between the 2 bodies, there are opportunately, hinged the 2 heads and the 2 feet of the 2 mechanical crosses(X) (becoming the 2 opposite horizontal sides “up and down” of the parallelogramm(D)). Then those 2 crosses(X) hinge crosswisly (with their 4 arms) the 2 other opposite sides “right and left” of the same parallelogramm(D) Externally, these 2 inclining vertical sides hold the 2 opposite bushings(E1=vertical rotation stems) of the 2 steering, inclining, braking, parallel front wheels. Up above there's the bar(B) (with an end welded to the chassis) that welds also, at its 2 ends, the heads of the 2 parallel shock-absorbers(A); furtherly, in the middle of the same bar(B), there's welded the stemC) that brings the free turning cylinder linked-up to the handle-bars(M) and down to the driving leverage(E-E1).

On the 3 wheels vehicle, nothing changes in the rear side; the engine pass on the motion to the rear wheel via, either (1) belt and pulley or, (1) chain and crown etc. Then the inclination happens consequently to the forward steering action.

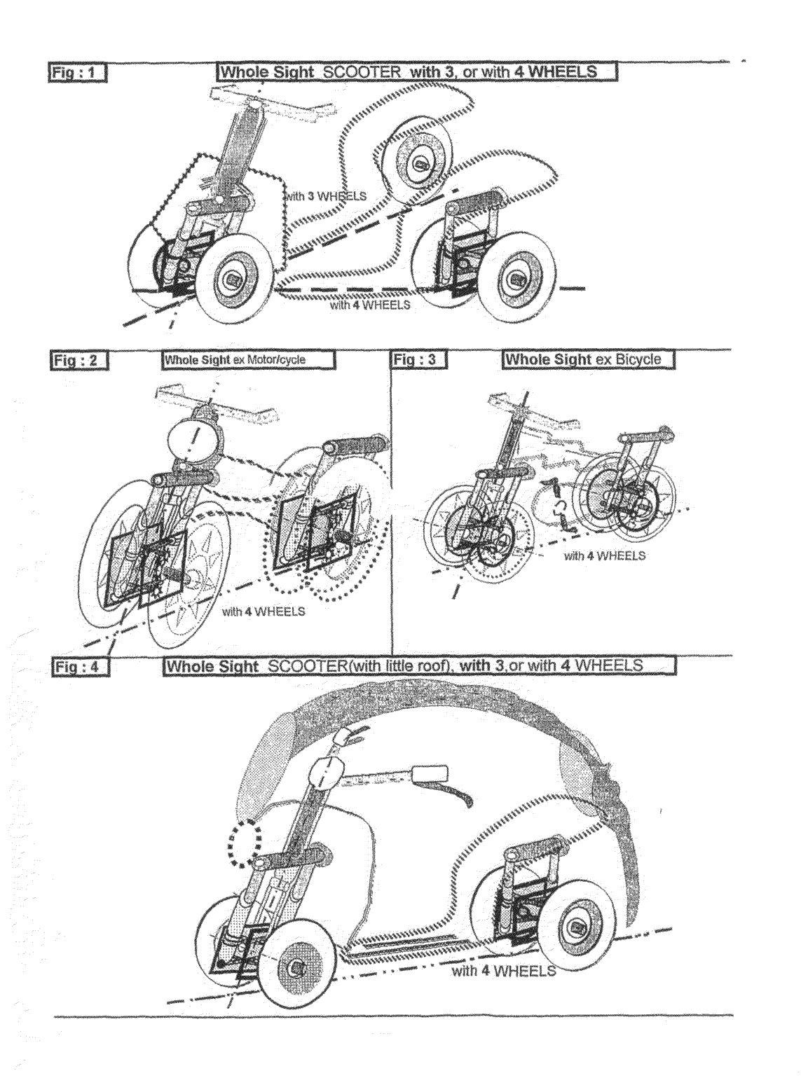

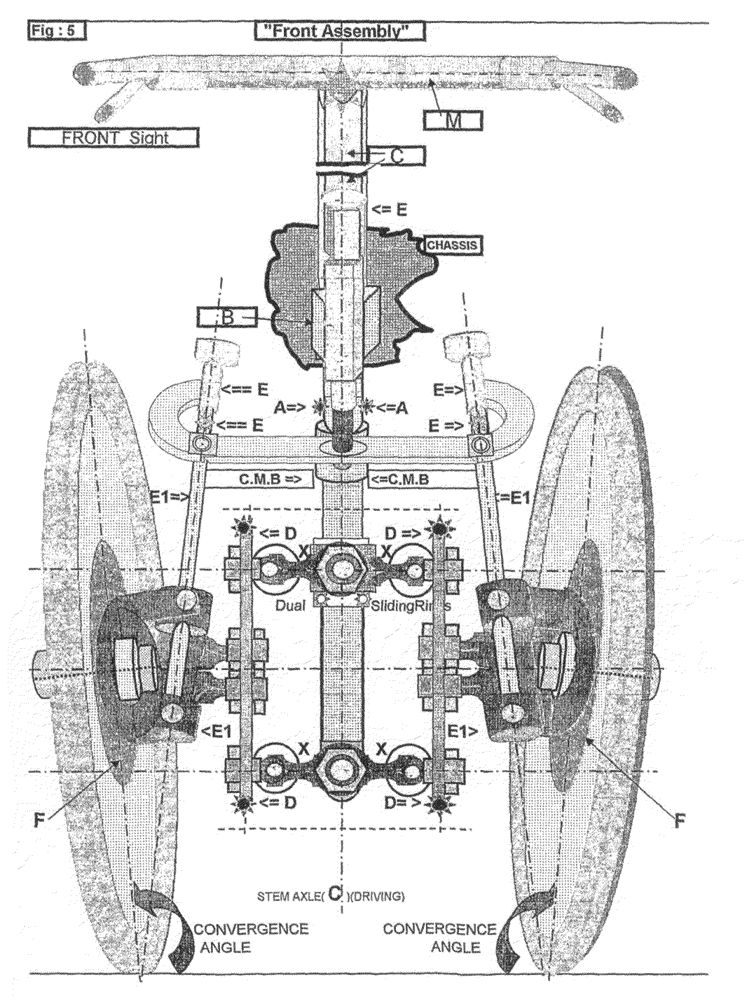

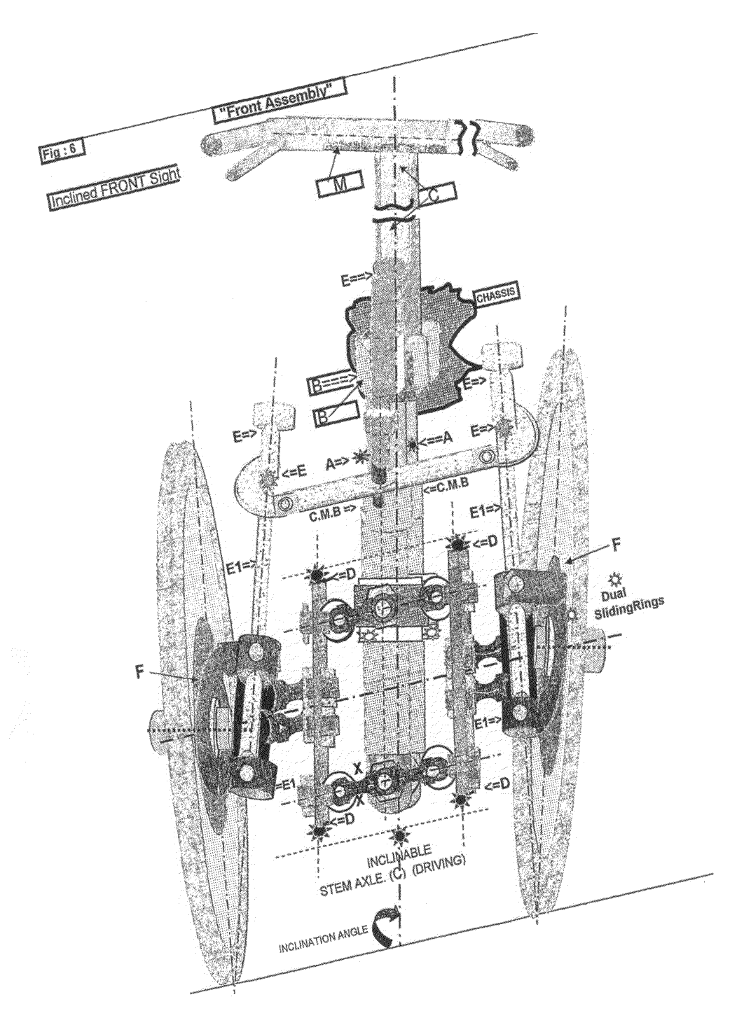

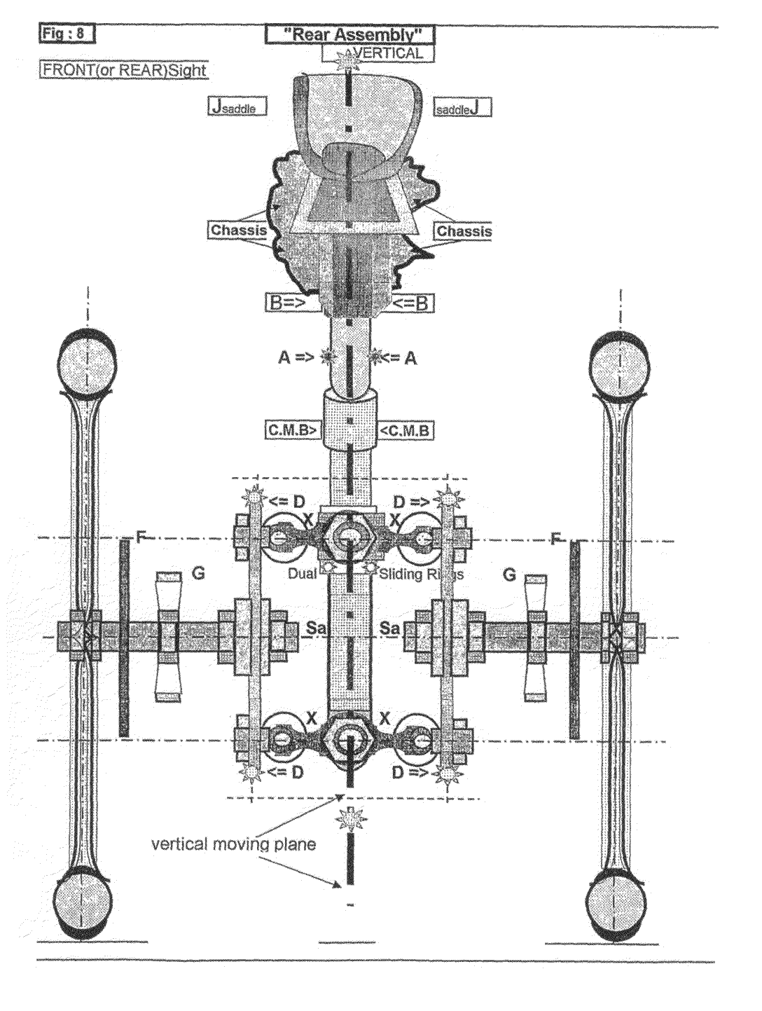

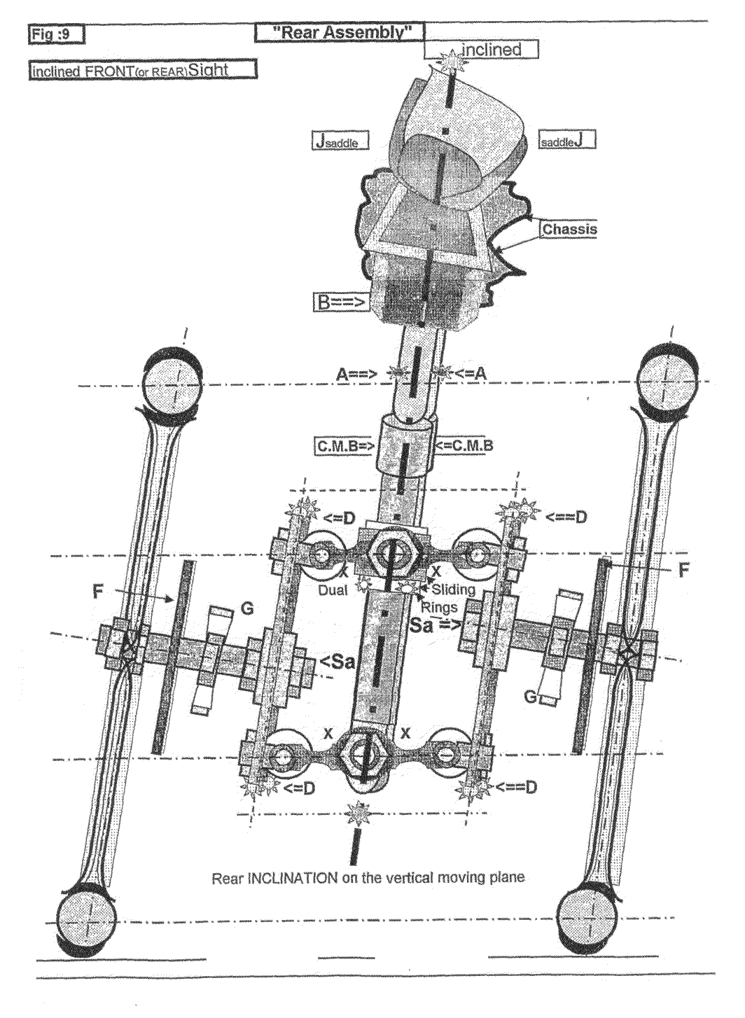

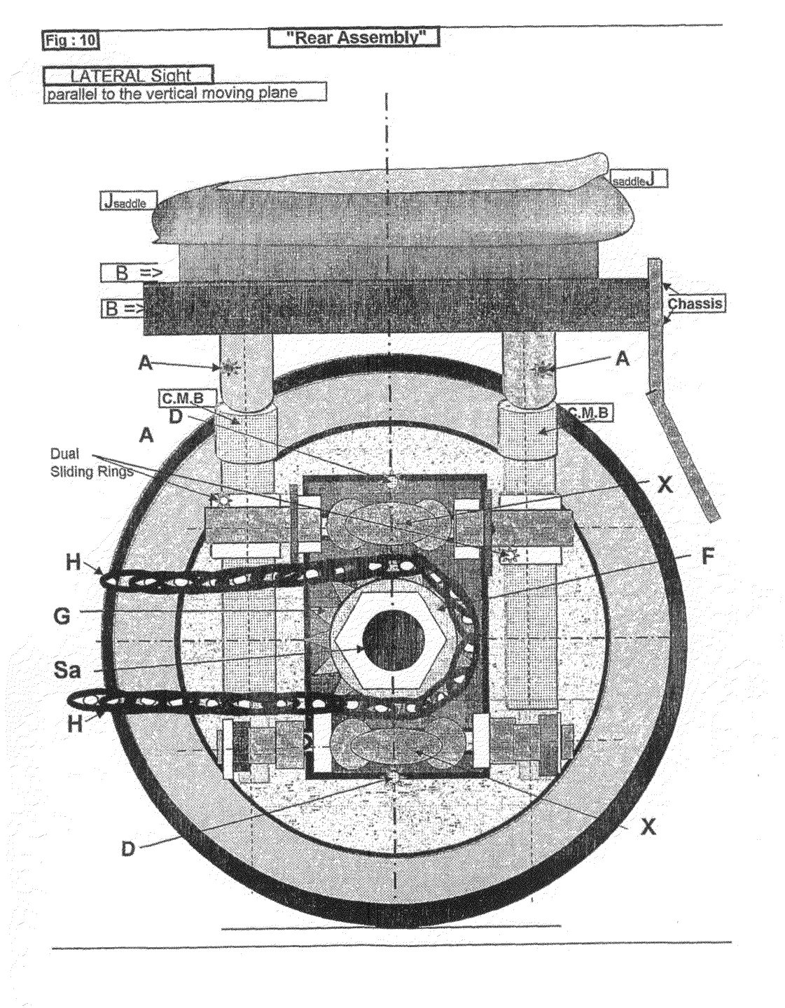

On the 4 wheels vehicle, (Page 1/7=FIGS. 2,3,4) the rear assembly is applicated with its 2 inclining, shock-absorbing, braking, parallel rear-wheels, but not steering. The engine pass on the motion to the 1 only or both rear wheels, via 1 only or both belts and pulleys or 1 only or both chains and crowns, moving 1 only or both wheels of the 2 rear-axles(Sa). Then the right inclination happens consequently to the forward steering action.
The “Rear Assembly” is reduced compare to the “Front assembly”; it's missing of the stem(C), of the subassemblies of 2 opposite bushings (E1=vertical rotation stems) and of the whole driving leverage(E-E1).
The “Rear Assembly” (Page 5/7=FIG. 8) has only the assembly of fork with the 2 parallel telescopic shock-absorbers(A) with the 2 mobile lower bodies (C.M.B.) “as the Front assembly”; but internally, between these 2 bodies, there is the parallelogramm(D) that supports externally, the 2 subassemblies of the 2 opposite rear-axels(Sa), linked 1 only or both to the engine; then those 2 subassemblies have other subassemblies of pulleys(G) and belts(H), or of crowns(G) and chains(H), of dishes(f) and brakes and at last, of the 2 rear wheels. On the 4 wheels vehicle, the “rear assembly” is only inclining, then the inclination happens consequently and synchronously to the forward steering action.

The criterions of realization for the 2 Front wheels=they must be:
.1F) parallel to the vertical moving direction and both equidistant from axle of handle-bars(M).
.2F) able to steer by the handle-bars(M) and its leverage(E-E1), linked down up to the 2 front wheels
.3F) able to incline, consequently and synchronously to the steering action.
.4F) able to shock-absorbe, by the 2 parallel front shock-absorbers(A), as usual.

The criterions of realization for the 2 Rear wheels=they must be:
.1R) parallel to the vertical central moving plane and both equidistant from central axle of vehicle.
.2R) Not able to steer. .3R) able to incline, synchronously to the forward steering action.
.4R) able to shock-absorbe, by the 2 parallel rear shock-absorbers(A), as usual.

1. System to build a steerable and inclinable vehicle with 3, or 4 wheels and/or to transform “Scooter-Cyclemotor-Bicycle-Motorcycle” into a steerable and inclinable vehicle with 3, or 4 wheels. The System (page 1/7=FIGS.:1,2,3,4) includes:
The “Front Assembly” (Page 2,3,4/7) having always 2 steering, inclining, shock-ab-sorbing, braking, parallel front-wheels, is suitable to the actual Biwheels means so to realize Triwheels means or, plus only inclining 2 rear-wheels, “1 or both linked to engine” to realize quadri-wheels means. This “Front Assembly” consists in a characteristic realization through precise sequences of merging and/or pairing of the essential subassemblies and their specific components, must follow the items from (.-1st- I-) to (.-1st- VI-):
-1st- I-) the 2 superior heads of the 2 parallel shock-absorbers(A) (that are lieing low into the central vertical moving plane of the vehicle, that is namely rotating of 90° compare to the all other actual shock-absorbers(A)) are welded to the 2 ends of the horizontal and complanar bar(B).
.-1st- II-) an end of its horizontal bar(B) is welded also to the chassis of the vehicle; in the middle of the same bar(B), there's welded the rigid stem(C) that brings the free turning cylinder linked-up stiffly to the handle-bars(M).
.-1st- III-) the 2 horizontal crosses(X) “up and down” rotate internally between the 2 vertical shock-absorbers(A), because are hinging (with their heads and feet) against the 2 mobile lower bodies(C.M.B.), becoming the 2 opposite horizontal sides of the parallelogramm(D). The 2 horizontal crosses(X), now, follow the mobile lower bodies(C.M.B) oscillations.
.-1st- IV-) the 4 ends of the previous 4 horizontal crosses arms have hinged internally the 2 other opposite vertical sides(left and right) of the parallelogramm(D), becoming now inclining
.-1st- V-) These 2 opposite vertical sides have hinged externally the 2 bushings(E1) (left and right), supporting of the further essential subassemblies of the 2 front wheels: subassemblies as dishes and brake, part of leverage(E-E1) etc.
.-1st- VI-) The stem(C), being the pivot of the handle-bars(M), via the driving leverage(E-E1), commands to steer and also commands to incline pushing crosswisly the handle-bars(M).
Now this front part is able to permit the vehicle to steer and incline.
NOTE: This System (when becomes a 3steering and inclining wheels vehicle) permits parallely the inclining also to the rear wheel. The shock-absorbers oscillations are regularly efficient either forward or backward exactly like before the variation.

2. System to build a steerable and inclinable vehicle with 3, or 4 wheels and/or to transform “(Scooter-Cyclemotor-Bicycle-Motorcycle” into a steerable and inclinable vehicle with 3, or 4 wheels. The System (Page 1/7=FIGS.: 1,2,3,4) includes:
The “Front Assembly” that has the “2 steering, inclining, shock-absorbing, braking, parallel front wheels”.
The “Rear Assembly” that has the “2 inclining, shock-absorbing, braking, parallel rear wheels”).
This “Rear Assembly”(Page 5,6,7/7) consists in a characteristic realization through precise sequences of merging and/or pairing of the essential subassemblies and their specific components, as written in the 1st claim, but reduced of some subassemblies and some specific components, that are suited to obtain the same rear-inclination while steering. The Rear Assembly, having always 2 rear wheels, only inclining “1 or both lined to engine”, must follow the items from (.-2nd- I-) to (.-2nd- V-):
.-2nd- I-) the 2 superior heads of the 2 parallel shock-absorbers(A) that are lieing low into the vertical moving central plane of the vehicle, are welded to the 2 ends of the horizontal and complanar bar(B)
.-2nd- II-) one end of its horizontal bar(B) is welded to the chassis of the vehicle;
.-2nd- III-) the 2 horizontal crosses(X) “up and down” rotate internally between the 2 vertical shock-absorbers(A), because are hinging (with their heads and feet) against the 2 mobile lower bodies(C.M.B.), becoming the 2 opposite horizontal sides of the parallelogramm(D). The 2 horizontal crosses(X), follow, now, the mobile lower bodies(C.M.B) oscillations.
.-2n- IV-) the 4 ends of the previous 4 horizontal crosses arms are hinged internally to the other 2 opposite vertical sides(left and right) of the parallelogramm(D), now becoming inclining.
.-2nd- V-) These 2 opposite vertical sides support externally the 2 opposite rear-axels(Sa) (left and right), supporting the further essential subassemblies of the 2 rear wheels “1 or both to engine”: subassemblies like pulleys(G) for belts(H) or crowns(G) for chains(H), dishes(F) and
NOTE: This system (when becomes a 4 steerable and inclinable wheels vehicle) backly inclining only, that's namely due to the peculiar combinations of its previous characteristics, in steering mode, forces parallely also the inclining to the 2 rear wheels. he shock-absorbers oscillations are regularly efficient either forward then backward exactly like before of the variation.

3. The third claim (of the System, written in DESCRIPTION) is on the original functional idea of these 2 assemblies, basically founded on the precise rules of merging and pairing (crosswisly and directly and crosswisly again) of their essential subassemblies and their specific components to obtain the precise functionalities (shock-absorbing/steering/inclining) either, for the steerable and inclinable 3 wheels, or 4 wheels vehicles.
The assembly of the 2 front parallel telescopic shock-absorbers(A) with mobile lower bodies(C.M.B.) (for vehicles with 3 and or 4 wheels), and, eventually, the similar assembly of 2 rear parallel telescopic shock-absorbers(A) with mobile lower bodies(C.M.B.)(only for vehicles with 4 wheels), must have their principal axels lieing low into the vertical moving central plane, that are namely rotating of 90° compare to the other actual shock-absorbers(A), and, complanarly they must hinge the 2 horizontal axels of the crosses(X) (with their heads and feet) internally, against the 2 mobile lower bodies(C.M.B.). Further crosswisly the 2 crosses(X) (with their 4 arms) must hinge the 2 opposite sides (left and right) to complete the parallelogramm(D). Then the parallelogramm(D) of the front assembly, must only hinge externally crosswisly the 2 opposite assemblies of bushings(E1=vertical rotation stems) of the 2 steering, inclining, braking, parallel front-wheels so to obtain the right functionalities (shock-absorbing/steering/crosswisly inclining).
This third claim is referred to the original idea of functioning of these assemblies, due to the whole realization that has been concepted namely to keep the centres of gravity of the assembly weights as low as possible (pairly or nearly to the 2 wheels centres) in way to give high stability to the vehicle either in stop or in movement mode: “Principal goal of this Patent”.

4. The fourth claim (of the System, in DESCRIPTION written) is referred to the specific realization of the parallelogramm(D) “with crosses(X)”, changing from the rectangler to rhomber shape, managing the inclination. Then the specific realization of the horizontal sides can be built entirely by 2 or more crosses(X) and pairly by 2 or more vertical crosses(X) and also if, each cross(X) can have 2 or more arms; the horizontal crosses(X) must hinge (with their heads and feet) internally, against the 2 opposite mobile lower bodies(C.M.B) and pairly it must hinge (with their 4 or more arms) against the 2 or more vertical crosses(X) (with their 4 or more arms).

5. The fifth claim (of the System, in DESCRIPTION written) is referred to the specific realization of the parallelogramm(D) “with plates(X)”, changing from the rectangler to rhomber shape, managing the inclination. Then the specific realization of the horizontal and vertical sides can be built entirely by 2 or more geometric mechanical plates(X) opportunately cut and supported so that the horizontal plates(X) (with their artificial heads and feet, in the middle axel, similarly to the crosses(X)) must hinge, against, internally the 2 opposite mobile lower bodies(C.M.B) and pairly they must opportunately hinge(with their 4 or more sides) against the 2 or more vertical plates(X) (with their 4 or more sides) opportunately cut and supported (as shown).
